(19) United States
(12) Patent Application Publication
(10) Pub. No.: US 2024/0158043 A1
(43) Pub. Date: May 16, 2024

(54) WIRELESS 3 WHEELED MORTORIZED VECHICLE

(71) Applicant: Marc Fernandez, Orlando, FL (US)

(72) Inventor: Marc Fernandez, Orlando, FL (US)

(21) Appl. No.: 17/986,057

(22) Filed: Nov. 14, 2022

(51) Int. Cl. B62M 7/12

(52) U.S. Cl. CPC B62M 7/12; B62K 21/00

(57) ABSTRACT

The present disclosure is directed to a motorized vehicle system, apparatus, and method. The motorized vehicle system, apparatus, and method may include a portable vehicle including a removable electrical battery. The powertrain of the vehicle may be provided by the vehicle wheels. The vehicle may be steered by a user's feet. Acceleration of the vehicle may be controlled by the user via a remote controller.

### TECHNICAL FIELD

The present disclosure is directed to a vehicle system, apparatus, and method, and more particularly, to a motorized vehicle system, apparatus, and method.

### BACKGROUND OF THE DISCLOSURE

Conventional electrical vehicles typically include batteries fixed to the vehicle that may be plugged into an electricity source. Such electrical vehicles are usually parked or left near the electrical source during charging. Further, such electrical vehicles are typically non-portable and difficult to move except by the vehicle's powertrain.

The exemplary disclosed system, apparatus, and method of the present disclosure is directed to overcoming one or more of the shortcomings set forth above and/or other deficiencies in existing technology.

### BRIEF DESCRIPTION OF THE DRAWINGS

Accompanying this written specification is a collection of drawings of exemplary embodiments of the present disclosure. One of ordinary skill in the art would appreciate that these are merely exemplary embodiments, and additional and alternative embodiments may exist and still be within the spirit of the disclosure as described herein.

FIG. 1 is a perspective front view of at least some exemplary embodiments of the present disclosure;

FIG. 2 is a perspective side view of at least some exemplary embodiments of the present disclosure;

FIG. 3 is a perspective side view of at least some exemplary embodiments of the present disclosure;

FIG. 4 is a perspective view of at least some exemplary embodiments of the present disclosure;

FIG. 5 is a perspective back view of at least some exemplary embodiments of the present disclosure;

FIG. 6 is a perspective view of at least some exemplary embodiments of the present disclosure;

FIG. 7 is a perspective view of at least some exemplary embodiments of the present disclosure; and

FIG. 8 is a perspective view of at least some exemplary embodiments of the present disclosure.

### DETAILED DESCRIPTION AND INDUSTRIAL APPLICABILITY

In at least some exemplary embodiments, the exemplary disclosed system, apparatus, and method may include a vehicle system 100 having a vehicle 105 and a controller 106. Controller 106 may control an operation of vehicle 105.

Vehicle 105 may include a structural assembly 110 that may structurally support components of vehicle 105 and a user (e.g., a rider) that may operate vehicle 105. Structural assembly 110 may include a rear assembly 115 and a front assembly 120 that may be attached to each other.

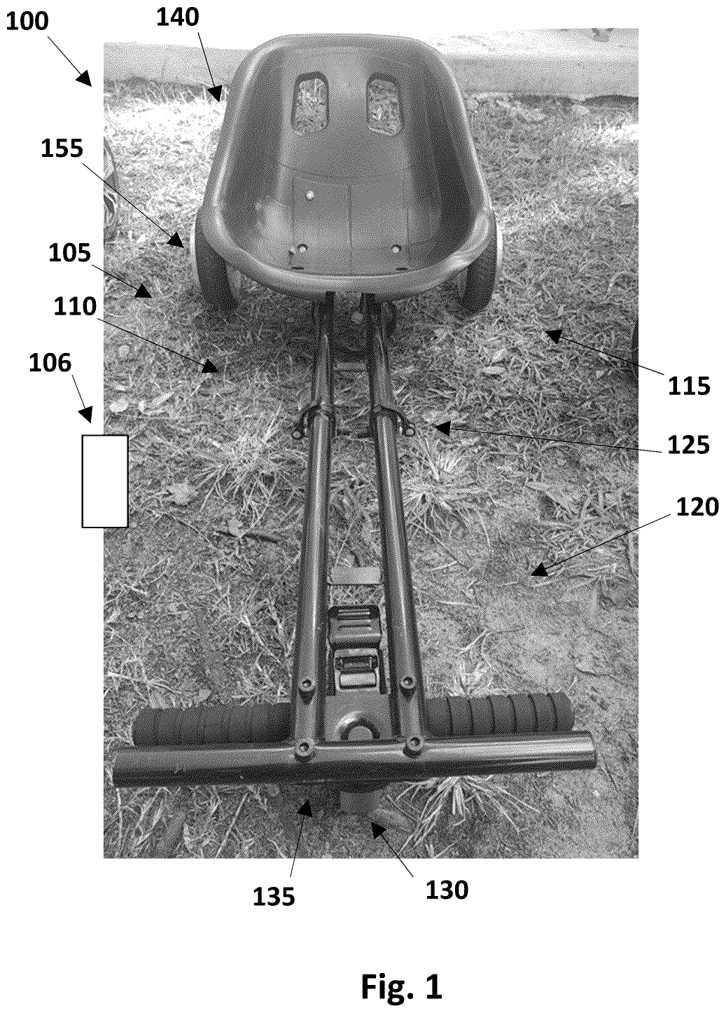

In at least some exemplary embodiments and as illustrated in FIG. 1, rear assembly 115 and front assembly 120 may be structural frames (e.g., T-frames). Rear assembly 115 and front assembly 120 may be adjustably fastened together via a fastener assembly 125. For example as illustrated in FIG. 1, rear assembly 115 may include one or more members (e.g., one or two strut members) that may receive one or more members (e.g., one or two strut members) of front assembly 120. One or members of front assembly 120 may alternatively receive one or more members of rear assembly 115. For example, the members of front assembly 120 may be telescopically received in the members of rear assembly 115 (e.g., the members of rear assembly 115 may be hollow members that movably receive the members of front assembly 120). Fastener assembly 125 may include fasteners (e.g., clamps, cotter pins, and/or any other suitable fastener) that may fix the members of front assembly 120 relative to the members of rear assembly 115 at any desired length. Users may thereby use fastener assembly 125 to lock the members of front assembly 120 relative to the members of rear assembly 115 to provide a comfortable length of vehicle 105 (e.g., comfortable for the user's height and/or leg length). The members of front assembly 120 may be substantially fully telescopically received (e.g., or received to a largest amount) in the members of rear assembly 115 to provide vehicle 105 in a portable configuration that may be relatively easy for a user to carry.

In at least some exemplary embodiments, the members of rear assembly 115 and front assembly 120 may be hollow structural members such as hollow tubes. Components of structural assembly 110 may be formed from any suitable material such as metal, plastic, wood, and/or any other suitable structural material. Components of structural assembly 110 may be formed from lightweight structural material. Components of structural assembly 110 may be formed from steel, aluminum, and/or graphite. For example, the members of rear assembly 115 and front assembly 120 may be metal (e.g., steel) hollow tubes. Materials and/or a shape or configuration of structural assembly 110 for example as illustrated in FIG. 1 may provide an assembly of between about 25 and about 30 pounds or any other suitable weight (e.g., for a portable vehicle).

Front assembly 120 may include a front wheel assembly 130 and a brake assembly 135. Front wheel assembly 130 may be attached to front assembly 120 and may support vehicle 105 along with the other exemplary disclosed wheels during a movement of vehicle 105. Brake assembly 135 may be selectively operated by a user to stop (e.g., brake) vehicle 105.

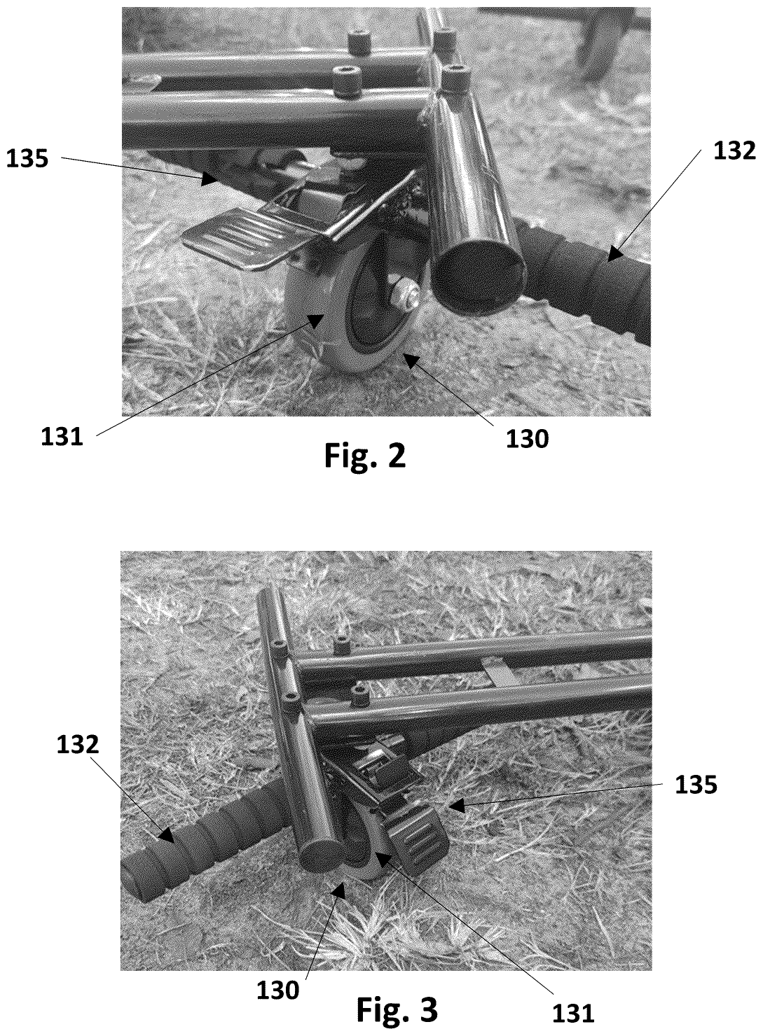

For example as illustrated in FIGS. 2 and 3, front wheel assembly 130 may be rotatably attached to front assembly 120. Front wheel assembly 130 may include a wheel 131 that may be attached to a member 132 (e.g., a bar or cross-bar). Users may use their feet to rotate wheel assembly 130 by pushing on member 132. Member 132 may include any suitable grip material (e.g., rubber or elastomeric material or any other suitable material for increasing grip) to facilitate users pushing on member 132 with their feet to rotate wheel assembly 130 (e.g., wheel 131 may be attached to member 132 so that is rotates with member 132). For example, users may rest the bottom of their shoes on front assembly 120 (e.g., a front cross-bar of front assembly 120) and then use their heels to push on either side of member 132 to rotate front wheel assembly 130 as desired. A user may thereby steer vehicle 105 by rotating front wheel assembly 130. Wheel assembly 130 may be configured (e.g., weighted) so that wheel assembly 130 moves to a default position moving vehicle 105 straight forward when vehicle 105 moves under power for example as described herein (e.g., when a user may or may not be sitting on vehicle 105).

As illustrated in FIGS. 2 and 3, brake assembly 135 may include an actuator (e.g., a pedal or pad) that may be selectively pushed by the user's feet when desired. A bottom surface of the pad, which may be treated with or include a surface portion with relatively high frictional properties (e.g., a rough surface of material such as tread or other friction-inducing material such as rubber), may be pushed against wheel 131 to slow and/or substantially stop vehicle 105 (e.g., in addition to stopping the powertrain of vehicle 105 for example as described herein). In at least some exemplary embodiments, brake assembly 135 may be spring-loaded to return it from a braking position against wheel 131 to a non-braking position when it is not being pressed by a user.

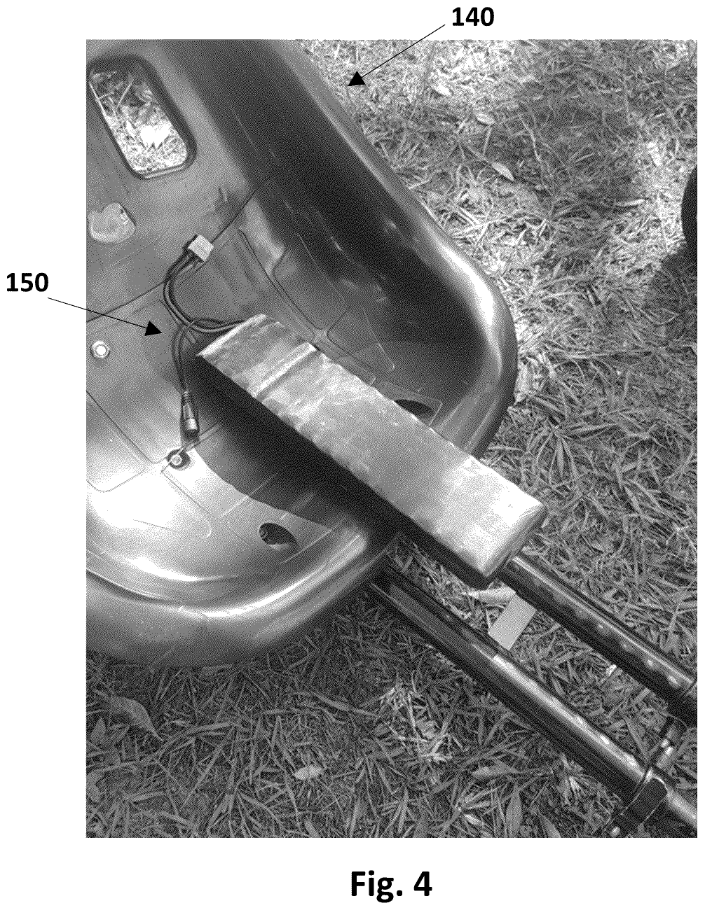

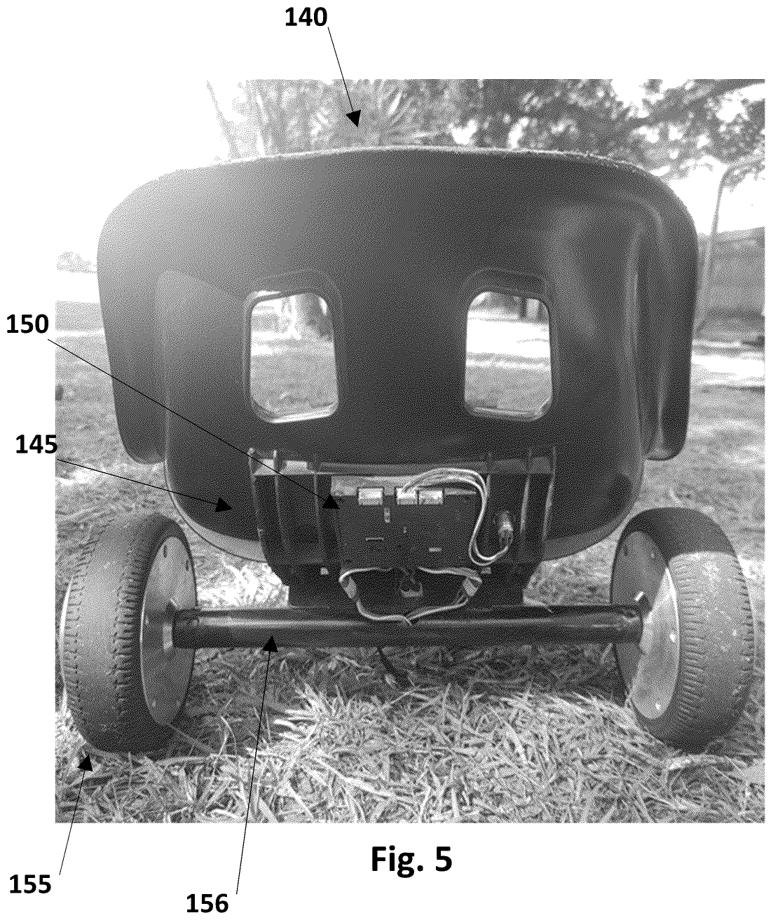

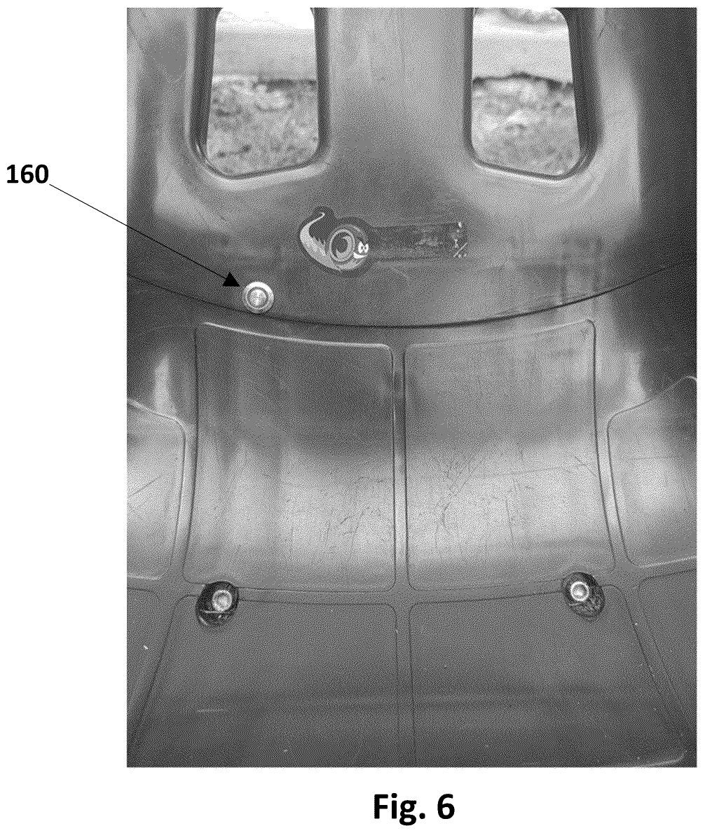

As illustrated in FIGS. 4 and 5, rear assembly 115 may include a seat 140 that may be attached to an upper portion or surface of rear assembly 115. Seat 140 may be formed from any suitable material such as plastic or other suitable material for supporting a user. Seat 140 may be attached for example to the exemplary disclosed members of rear assembly 115. A user may be seated in seat 140 during an operation of vehicle 105.

A battery support 145 may be attached to rear assembly 115. For example, battery support 145 may be attached to seat 140 (e.g., to a rear portion of seat 140 for example as illustrated in FIG. 5). Battery support 145 may be formed from plastic or any other suitable material for removably supporting a battery 150. Battery support 145 may include any suitable fastening device for removably receiving and/or attaching to battery 150 such as, for example, a mechanical fastener, a hook and loop fasteners, a clip, an adhesive strip, and/or any other suitable devices. Battery support 145 may include electrical connectors (e.g., electrical lines, wires, or leads) that may electrically connect battery 150, when supported in or at battery support 145, to one or more rear wheels 155. For example when battery 150 is removably received in or attached to battery support 145, electrical contacts or connectors of battery support 145 that are connected to the exemplary disclosed connectors or wires may electrically connect to battery 150. The electrical connectors (e.g., wires) may for example extend from battery 150 supported in battery support 145 to rear wheels 155 by extending within and running within a member 156 (e.g., a cross member) of rear assembly 115 for example as illustrated in FIG. 5. The exemplary disclosed wires or lines may also extend along an exterior surface of rear assembly 115. Battery 150 may thereby be electrically connected to rear wheel 155 when battery 150 is attached to or received in battery support 145. Battery support 145 and/or the exemplary disclosed electrical connectors or lines may be coated with and/or covered by any suitable waterproofing material such as plastic or sealant so that the electrical connection between battery 150 and rear wheels 155 may be substantially water-resistant and/or waterproof.

Battery 150 may be any suitable energy storage component. Battery 150 may be a rechargeable battery. For example, battery 150 may include a nickel-metal hydride battery, a lithium-ion battery, an ultracapacitor battery, a lead-acid battery, and/or a nickel cadmium battery. Battery 150 may be any suitable power storage that may be recharged and that may be used to provide charge to vehicle system 100. In at least some exemplary embodiments, battery 150 may be a lithium-ion 10A battery that may for example power vehicle 105 for a plurality of hours (e.g., 2½ hours). A plurality of batteries 150 may be attached to or stored on vehicle 105 so that, for example, a given battery 150 may serve as a spare battery while another battery 150 is connected to battery support 145 to power vehicle 105. Battery 150 may also be used to power electrical components of vehicle 105 such as front lights or headlights, brake lights (e.g., that may flash when controller 106 controls rear wheels 155 for example as described herein), and/or any other suitable components of vehicle 105.

Battery 150 may be a removable, rechargeable battery that may be removably attached to battery support 145. For example, battery 150 may be detached from vehicle 105 and charged in a different location from which vehicle 105 is located. Vehicle 105 may be powered by a second battery 150 when a first battery 150 has been removed from vehicle 105 and is being charged in a different location from vehicle 105.

Vehicle 105 may include one or more (e.g., two or more) rear wheels 155. One or more rear wheels 155 may be powered by battery 150, may be controlled by controller 106, and may serve as the powertrain of vehicle 105. Rear wheel 155 may include a receiver, transceiver, and/or any other suitable communication device that may communicate with controller 106 using the exemplary disclosed communication techniques. In at least some exemplary embodiments, front wheel 131 may be powered and controlled similarly to rear wheel 155. Rear wheel 155 may be rotatably attached to member 156. Member 156 may for example serve as a fixed rear axle of vehicle 105 to which rear wheels 155 may be rotatably attached.

Rear wheel 155 may include any suitable type of motor such as an electric motor. Rear wheel 155 may include a 3-phase motor. For example, rear wheel 155 may include a brushless motor. Rear wheel 155 may be controlled by controller 106 to act as a reversible motor. Rear wheel 155 may include a 3-wire arrangement (e.g., positive, negative, and neutral) electrically connected to battery 150 and controlled by controller 106. Rear wheel 155 may include a Hall sensor (e.g., sensor array) including an electromagnet that senses and communicates to controller 106 the position at which rear wheel 155 is disposed. Controller 106 may control rear wheel 155 to rotate forward and backward at any desired exemplary disclosed speed based on sensed data sensed by the exemplary disclosed sensor and transferred to controller 106 by the exemplary disclosed communication techniques.

Rear wheel 155 may also serve as a generator. When for example vehicle 105 is at a stationary position, users may physically roll vehicle 105 with their legs or by shifting their inertia, which may physically roll rear wheels 155 and vehicle 105. The rolling of rear wheels 155 may cause the exemplary disclosed motor (e.g., motor-generator) of rear wheel 155 to generate electricity, which may be transferred to the Hall sensor (e.g., that may include the exemplary disclosed transceiver or receiver), battery 150, and/or any other desired component of vehicle 105. Data or signals indicating that the generated electricity has been produced may be transferred to controller 106 and/or any other desired component of vehicle system 100, indicating that vehicle 105 has initiated or “woken up.” In at least some exemplary embodiments, vehicle system 100 may not operate until this exemplary “waking up” has occurred. Accordingly, the “waking up” may provide a safety feature for vehicle system 100, with vehicle 105 unable to be moved or powered electrically until vehicle 105 is physically moved (e.g., by a user sitting in seat 140). This may help to reduce or substantially prevent the chance of vehicle 105 being unintentionally started by an incorrect or unintended manipulation of controller 106.

Controller 106 may communicate with any suitable components of vehicle system 100 such as vehicle 105 and/or components that operate in conjunction with vehicle system 100. Controller 106 may be a remote controller, a touchscreen device (e.g., a smartphone, a tablet, a smartboard, and/or any suitable computer device), a computer keyboard and monitor (e.g., desktop or laptop), an audio-based device for entering input and/or receiving output via sound, a tactile-based device for entering input and receiving output based on touch or feel, a smart watch, Bluetooth headphones, a dedicated user device or interface designed to work specifically with other components of vehicle system 100, and/or any other suitable user device or interface. For example, vehicle 105 may be controlled remotely via controller 106. Controller 106 may be a digital remote controller. Controller 106 may communicate via a network component such as a WAN. Controller 106 and vehicle 105 (e.g., a communication device of rear wheel 155) may communicate with each other and/or any other suitable component of vehicle system 100 via any suitable communication method such as, for example, radio frequency communication (e.g., RF communication such as short-wavelength radio waves, e.g., UHF waves), infrared communication, wireless communication (e.g., CDMA, GSM, 3G, 4G, and/or 5G), direct communication (e.g., wire communication), Bluetooth communication coverage, Near Field Communication (e.g., NFC contactless communication such as NFC contactless payment methods), and/or any other desired communication technique.

Controller 106 may control an operation of some or all components of vehicle system 100. Controller 106 may be any suitable computing device for controlling an operation of components of vehicle system 100. Controller 106 may be a microcontroller. Controller 106 may, for example, include a processor (e.g., micro-processing logic control device) or board components. Also for example, controller 106 may include input/output arrangements that allow it to be connected (e.g., via wireless, Wi-Fi, Bluetooth, or any other suitable communication technique) to other components of vehicle system 100. For example, controller 106 may control an operation of components of vehicle system 100 based on input received from a user via a user interface of controller 106 (e.g., one or more buttons, switches, dials, triggers, and/or any other suitable interface), a software module of vehicle system 100 (e.g., running on hardware mounted on vehicle 105 and/or cloud-based systems), and/or any other suitable input and/or commands. For example, the one or more software modules may include computer-executable code stored in non-volatile memory. The one or more modules may also operate using a processor (e.g., as described for example herein). The one or more modules may store data and/or be used to control some or all of the exemplary disclosed processes described herein. In at least some exemplary embodiments, controller 106 (e.g., and/or any other desired component of vehicle system 100) may be a smart component in which the exemplary disclosed module or modules may be integrated.

Controller 106 may communicate directly with rear wheels 155 (e.g., via the exemplary disclosed receiver or transceiver) that may be powered by battery 150. Controller 106 may be controlled by a user to control rear wheels 155 to rotate to move vehicle 105 forward or backwards at any desired speed (e.g., up to about 17 or 18 mph, up to or about 25 mph, and/or any other desired speed) or predetermined speed level. For example, a user may sit in seat 140 and manipulate the user interface of controller 106 to move rear wheels 155 (e.g., and vehicle 105) either forward or backwards at a slow, medium, fast, or very fast (e.g., “turbo” speed). Controller 106 may also control rear wheels 155 to stop rotating (e.g., to stop vehicle 105). For example, controller 106 may control rear wheels 155 to reverse polarity or to stop rotating to thereby act as an electronic brake. Controller 106 may control rear wheels 155 to rotate in different directions.

An indicator 160 may be disposed on or in vehicle 105 at any desired location. For example, indicator 160 may be disposed at a surface of seat 140 for example as illustrated in FIG. 6. Indicator 160 may be electrically connected to and powered by battery 150 similar to as described above regarding rear wheel 155. Indicator 160 may communicate with controller 106 similarly to as described above regarding rear wheel 155 and/or may communicate with rear wheel 155. Indicator 160 may indicate whether or not indicator 160 and/or rear wheel 155 are in communication with (e.g., in remote control communication with) controller 106. Indicator 160 may thereby provide a notification of whether vehicle 105 (e.g., including rear wheels 155) are out of range of controller 106. For example, indicator 160 be solid (e.g., steadily emit light and/or sound) when controller 106 is not in communication with indicator 160 and/or rear wheel 155. Also for example, indicator 106 may flash (e.g., or make any other suitable indication) when controller 106 is in communication with indicator 160 and/or rear wheel 155. Rear wheels 155 may stop movement (e.g., stop a movement of vehicle 105) when controller 106 is not in communication with indicator 160 and/or rear wheel 155. Also for example, electrical current provided to rear wheels 155 from battery 150 may be automatically stopped when controller 106 is not in communication with indicator 160 and/or rear wheel 155.

In at least some exemplary embodiments, users may operate vehicle 105 by sitting on seat 140 with their feet steering front wheel assembly 130 for example as described above and holding controller 106. Users may steer vehicle 105 by pushing on front wheel assembly 130 while controlling an acceleration and/or deceleration (e.g., in forward or reverse) and speed of vehicle 105 by using controller 106 to control rear wheels 155.

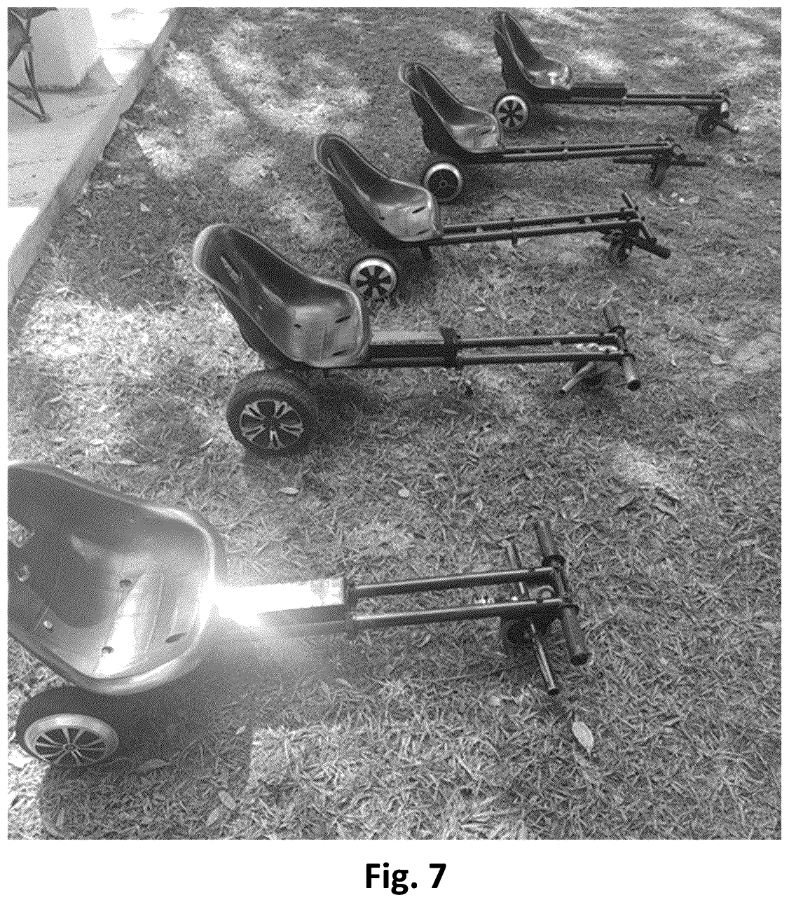

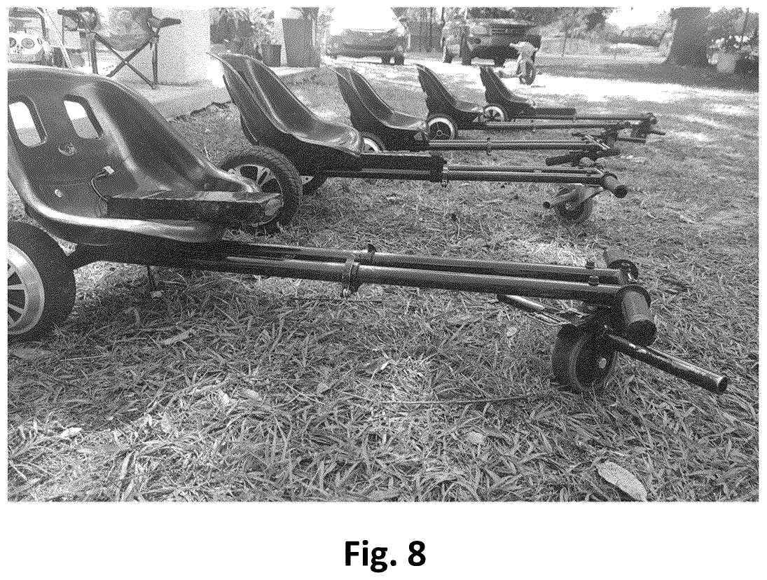

FIGS. 7 and 8 illustrate additional exemplary embodiments of the exemplary disclosed system, apparatus, and method. For example as illustrated in FIGS. 7 and 8, the exemplary disclosed vehicles may have varying rear wheel sizes to provide for off-road, faster and higher-powered movement, and/or any other desired applications.

The exemplary disclosed system, apparatus, and method may be used in any suitable application involving a vehicle. The exemplary disclosed system, apparatus, and method may be used in any suitable three-wheeled vehicle or a vehicle with any suitable number of wheels (e.g., one, two, or more wheels). For example, the exemplary disclosed system, apparatus, and method may be used in conjunction with any suitable vehicle such as a bicycle, a tricycle, an all-terrain vehicle, or any other suitable vehicle.

The exemplary disclosed system, apparatus, and method may provide an efficient and effective mode of transportation. The exemplary disclosed system, apparatus, and method may provide an intuitively simple technique for operating a vehicle. The exemplary disclosed system, apparatus, and method may provide a portable and lightweight electric vehicle that may be easily recharged.

While multiple embodiments are disclosed, still other embodiments of the present disclosure will become apparent to those skilled in the art from this detailed description. There may be aspects of this disclosure that may be practiced without the implementation of some features as they are described. It should be understood that some details have not been described in detail in order to not unnecessarily obscure the focus of the disclosure. The disclosure is capable of myriad modifications in various obvious aspects, all without departing from the spirit and scope of the present disclosure. Accordingly, the drawings and descriptions are to be regarded as illustrative rather than restrictive in nature.

What is claimed is:

1. A motorized vehicle as described herein.

2. A method for providing a motorized vehicle as described herein.

3. The invention as substantially described herein.
